(19) United States
(12) Patent Application Publication
(10) Pub. No.: US 2015/0350043 A1
(43) Pub. Date: Dec. 3, 2015

(54) METHODS AND ARRANGEMENTS FOR CHECKING CONNECTIVITY AND DETECTING CONNECTIVITY FAILURE

(71) Applicant: TELEFONAKTIEBOLAGET L M ERICSSON (PUBL), Stockholm (SE)

(72) Inventors: Ákos Kovács, Stockholm (SE); Lars Johansson, LINKÖPING (SE); Benny Sjöstrand, LINKÖPING (SE)

(21) Appl. No.: 14/759,050

(22) PCT Filed: Jan. 23, 2013
(86) PCT No.: PCT/SE2013/050049

§ 371 Date: Jul. 2, 2015

(51) Int. Cl. H04L 12/26; H04L 29/12

(52) U.S. Cl. CPC H04L 43/0811; H04L 61/103; H04L 43/106

(57) ABSTRACT

A method is presented for connectivity checking and detection of connectivity failure, based on a modified Ethernet ARP address resolution mechanism to detect broken connectivity on physical, data-link and network layer between a first and a second node. The detection mechanism uses Periodical Gratuitous ARP messages (PGARP). PGARP messages are sent by a first node, the sender host or Issuer. On the other side of a data path is a second node, receiver host or Listener configured to detect lost connectivity by means of missing PGARP messages. The process on the Listener then informs subscribing services, host local, or remote, about the state of the connectivity.

### TECHNICAL FIELD

The present invention relates to methods and arrangements for checking connectivity and detecting connectivity failure of data transmission paths in a network, e.g. Ethernet broadcast network.

### BACKGROUND

In certain network systems with high availability, it is also a requirement that the system shall be able to come over network failures. Failover mechanism is usually triggered by a connectivity detection mechanism which may be run either on data-link or on network layer. However, there can be a vast range of application scenarios where such mechanisms are demanded.

Existing solutions which can be used for detecting connectivity loss are, for example, IPv6 (Internet Protocol version 6) Neighbour Discovery, Internet Control Message Protocol (ICMP) Ping, Bidirectional Forwarding Detection and Ethernet OAM Connectivity Fault Management.

Some problems with the above existing solutions will hereafter be described.

The main disadvantage of the IPv6 Neighbour Discovery method is that, although it is getting more and more portion of the IP implementations, it is still not widely used. Moreover, it is a network layer mechanism, layer 3 (L3), in the Open Systems Interconnection (OSI) model scheme and it is possible that in some scenarios a suitable layer 2 (L2), data-link layer, solution is preferred. The method is described in reference [1], see reference list in the end of the Detailed Description section of this disclosure.

Internet Control Message Protocol, ICMP, Ping based detection is very simple and can be used with IPv4 (Internet Protocol version 4) protocol. The method uses a unique request/reply mechanism between connection endpoints. This has a drawback when multiple network elements are testing connectivity towards the same network element, putting a potentially huge processing load on that network element. If Quality of Service is used in the network, an ICMP packet often has the lowest priority traffic class and it is therefore dropped first if the network should be congested. Such an event usually only further escalates the problem the network is having. It is a network layer mechanism, Layer 3 in the OSI model.

Bidirectional Forwarding Detection, BFD, is a L3 detection mechanism that is mostly used in the routing world. Each supervised link requires a BFD supervision session on the top, which would need a tremendous amount of parallel sessions in case of certain scenarios where hosts are deployed very densely. Some systems have hardware and software limitation on the maximum number of possible BFD sessions at a time. Also, configuration wise it makes the system very difficult. Basically BFD has the same drawback as ICMP Ping. BFD was not designed to use for hosts checking connectivity. The method is described in reference [2], see reference list in the end of the Detailed Description section of this disclosure.

Ethernet OAM (Operations, Administration and Maintenance) Connectivity Fault Management, CFM, is a fault monitoring mechanism which uses the continuity check protocol. It is a L2, data-link layer, detection mechanism. This is a neighbor discovery and health check protocol which discovers and maintains adjacencies at a Virtual Local Area Network level or link level. The major disadvantage of this solution is that it can only detect faults on L1 and L2 but not higher layers (L3-L7) of the Open Systems Interconnection model scheme. The method is described in reference [3], see reference list.

However, the known connectivity detection mechanisms are dependent of the type of the network layer (L3) being used. Thus, there is a need for a sufficient and scalable data-link (L2) connectivity detection mechanism independent of the type of the network layer (L3) being used.

### SUMMARY

One object of this disclosure is to provide a sufficient and scalable data-link connectivity detection mechanism independent of the type of the network layer (L3) being used.

According to a first aspect, an arrangement and embodiments thereof are provided and described, which are adapted for checking connectivity and detecting connectivity failure of data transmission paths between one or more first nodes and one or more second nodes in a data communications network. Each of said first nodes comprises an issuing device and each of said second nodes comprises a listening device. Said listening device comprises a receiving device, a storing means and checking means. The receiving device is configured to receive an Address Resolution Protocol, ARP, message periodically sent from one of said first nodes over a data transmission path. The storing means is configured to store the time instant when said ARP message was received as an entry of the latest received ARP message from the first node in a record comprising entries corresponding to one or more data paths to said one or more first nodes. The checking means is configured to detect connectivity failure by periodically checking said record for entries in relation to a predetermined threshold value, aging value, and to detect if one or more of said entries have exceeded said predetermined threshold value.

According to another aspect, an arrangement and embodiments thereof are provided and described, which are adapted for arrangement for checking connectivity and detecting connectivity failure of data transmission paths between one or more first nodes and one or more second nodes in an Ethernet broadcast network. The arrangement in the first node comprises an issuing device configured to transmit periodically an Address Resolution Protocol, ARP, message towards a second node.

Different embodiments of the arrangements are described and provided in the following detailed description and the dependent claims.

According to yet another aspect, a method and embodiments thereof are presented, which provides possibility to check connectivity and detect connectivity failure of data transmission paths between one or more first nodes and one or more second nodes in a data communication network. Said second node is configured to receive an Address Resolution Protocol, ARP, message periodically sent from one of said first nodes over a data path, and to store the time instant when said ARP message was received as an entry of the latest received ARP message from the first node in a record comprising entries corresponding to one or more data transmission paths to said one or more first nodes. It then detects connectivity failure by periodically checking said record for one or more entries in relation to a predetermined threshold value, aging value.

According to yet further one aspect, a method and embodiments thereof are presented, which enables checking of connectivity and detecting connectivity failure of data transmission paths between one or more first nodes and one or more second nodes in an Ethernet broadcast network. In the first node, the method comprises transmitting periodically an Address Resolution Protocol, ARP, message towards a second node.

Different embodiments of the methods are described and provided in the following detailed description and the dependent claims.

### BRIEF DESCRIPTION OF THE DRAWINGS

The foregoing, and other, objects, features and advantages of the present invention will be more readily understood upon reading the following detailed description in conjunction with the drawings in which:

FIGS. 1A and 1B are block diagrams of exemplary networks in which arrangements and methods described herein may be implemented;

FIGS. 2A and 2B are block diagrams of exemplary networks in which arrangements and methods described herein have been implemented;

FIG. 3 is a flowchart illustrating an embodiment of the method for enabling checking and detecting connectivity failure;

FIG. 4 is a flowchart illustrating an embodiment of the method for checking and detecting connectivity failure;

FIG. 5 is a flowchart illustrating an embodiment of the checking and detecting process.

### DETAILED DESCRIPTION

In the following description, for purposes of explanation and not limitation, specific details are set forth, such as particular circuits, circuit components, techniques, etc. in order to provide a thorough understanding of the present invention. However, it will be apparent to one skilled in the art that the present invention may be practiced in other embodiments that depart from these specific details. In other instances, detailed descriptions of well-known methods, devices, and circuits are omitted so as not to obscure the description of the present invention with unnecessary detail.

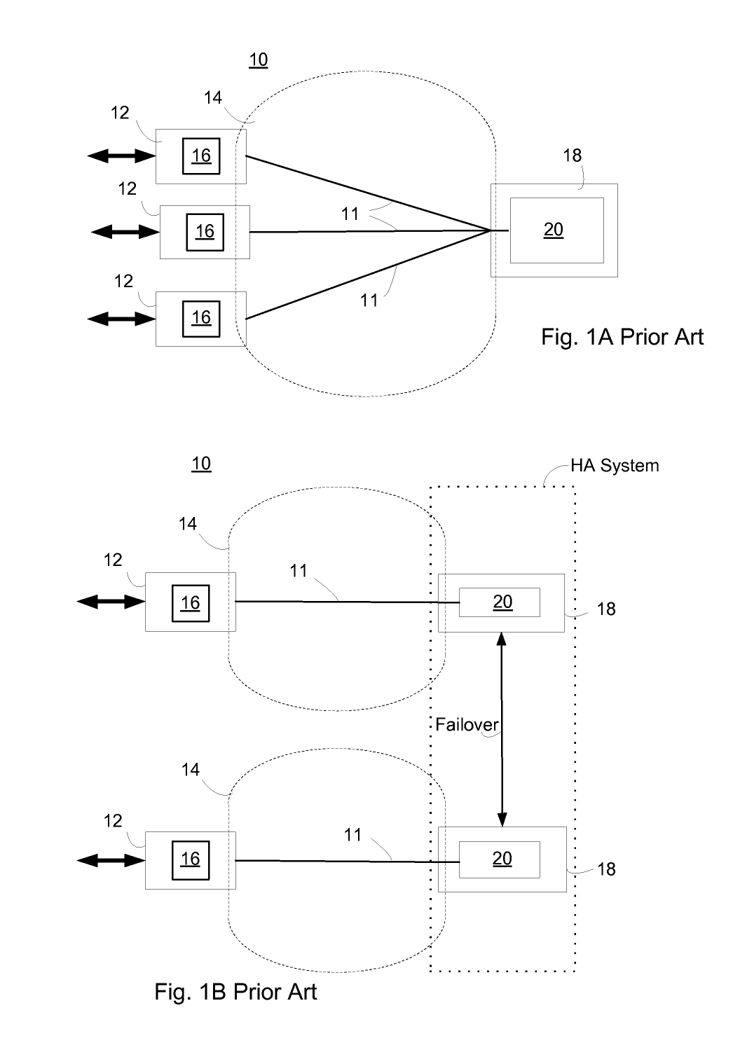

FIGS. 1A and 1B are block diagrams illustrating two examples of data communications networks and systems 10 having a number of edge nodes. In the illustrated examples, the two networks may be different embodiments of Local Area Networks, LANs, configurations e.g. Ethernet broadcast domain. Both examples are simplified.

In FIGS. 1A and 1B, the exemplified embodiments of the systems and networks 10 comprise network nodes 12 which purpose is to interconnect the LAN 14 with data communications network using other standards, e.g. protocols, for transferring data than the LAN 14. If the LAN is an Ethernet network and system, Ethernet frames are used for transferring incoming and outgoing data traffic. The connected network may be using Internet Protocol as standard, e.g. IPv4 or IPv6. Thus, the edge nodes may comprise equipment 16, e.g. one or more gateways or routers for routing the data traffic to the correct addresses.

In the exemplified LANs 14, the edge nodes 12 are connected to the subscriber nodes 18 via data paths 11, which may comprise one or more links via a number of switches. Said links and switches are not illustrated as said elements are not essential for the understanding of the methods and arrangements to be described in this disclosure.

The exemplified LANs 14 comprise edge nodes 12 connected via data (transmission) paths 11 to one or more subscriber nodes 18, which may connect one or more subscriber User Equipments, UEs, to the LAN. Different data communication products, e.g. office or home LAN routers, data computers, telecommunication equipments, e.g. Base Station Controllers, NodeB:s, eNB:s, and television sets, etc. are examples of different UEs that may be connected to said node 18. Each subscriber node 18 comprises interface equipment 20 for connecting the user equipments with the data paths 11 over the LAN 14.

The edge node equipment 16 and subscriber node equipment 20 may comprise elements and components for supporting detection of connectivity failure according to any of the known methods as described in the Background of this disclosure.

In FIG. 1A, three edge nodes 12 are interconnecting the subscriber node 18 to other networks (indicated by black double direction arrow) via data paths 11. If a failure or breakdown of one of the edge nodes 18 is detected by the node 18, the node 18 may be configured to direct the traffic originally designated to go via said non-operating node to one of the other nodes 12 still working.

A network and system as described above may be a High Availability, HA, system, which is often used in connection with telecommunication technologies.

In FIG. 1B, the illustrated example comprises a High Availability system, in which two subscriber nodes 18 are included. Each of said subscriber nodes 18 are connected to a separate data path 11, which connects a subscriber node 18 to an edge node 12. Said edge node 12, data path 11 and subscriber node constitute a blade. In the illustrated example, one Ethernet Broadcast domain 14 comprises a blade. However, both blades may be incorporated in the same Ethernet Broadcast domain 14.

The HA system applies a failover mechanism that moves traffic from one blade to the other. The failover mechanism is triggered if the HA system detects loss of connectivity. In case of loss of connectivity over the data path in one of the blades, both ingress and egress data traffic over said non-operating data path of the HA system is moved by the overlaying failover mechanism to the other working blade.

In the following, methods and arrangements for checking connectivity and detecting connectivity failure of data transmission paths between one or more nodes in Ethernet broadcast networks, e.g. as discussed above and illustrated in FIGS. 1A and 1B.

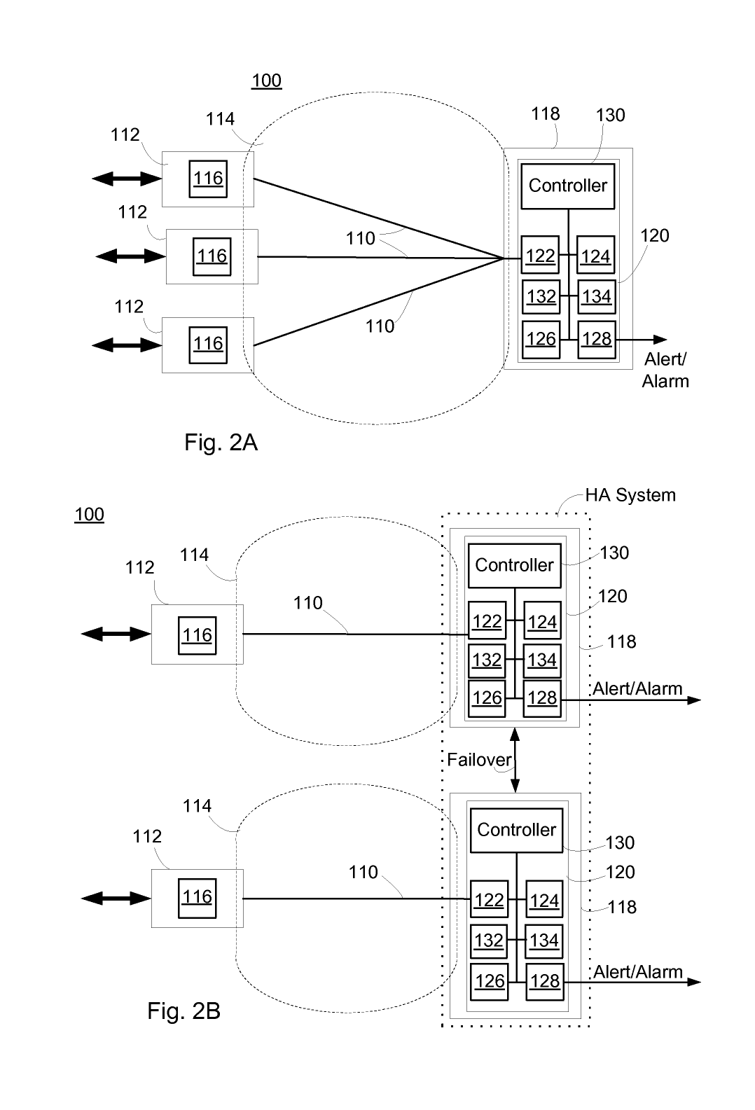

FIGS. 2A and 2B are illustrating two examples of embodiments of a data communications network, e.g. Ethernet broadcast networks, wherein methods and arrangements for checking connectivity and detecting connectivity failure of data transmission paths.

The network configuration in FIG. 2A corresponds to the network configuration illustrated in FIG. 1A and described above. In the similar way, the network configuration in FIG. 2B corresponds to the network configuration illustrated in FIG. 1B and described above. The arrangement 100 for checking connectivity and detecting connectivity failure of data transmission paths is adapted to be implemented in the first and second nodes. In the following description, for purpose of generalization, the edge nodes 12 in FIGS. 1A and 1B are denoted first nodes 112 and the subscriber nodes are denoted second nodes 118. The data paths 11 in FIGS. 1A and 1B corresponds to the data paths 110 in FIGS. 2A and 2B. The Ethernet broadcast domains 14 in FIGS. 1A and 1B corresponds to the Ethernet broadcast domains 114 in FIGS. 2A and 2B.

The first nodes 112 comprise an issuing device 116 besides other elements and components, e.g. gateway functionality, router functionality, etc., necessary for the functionality of a first node. Said other elements and components are not illustrated only for the purpose of avoiding details unnecessary for the understanding of the operation of the methods and arrangement.

According to one example of an embodiment of the arrangement 100 for checking connectivity and detecting connectivity failure of data transmission paths between one or more first nodes 112 and one or more second nodes 118 in an Ethernet broadcast network 114, the first nodes 112 comprises an issuing device 116 configured to transmit periodically an Address Resolution Protocol, ARP, message towards a second node 118. The ARP message may be a Gratuitous ARP, GARP, message comprising a Sender's Protocol Address, SPA, field and a Target Protocol Address, TPA, field, wherein the issuing device 116 is configured to set the Sender's Protocol Address, i.e. the protocol address of the first node, into the TPA field, i.e. TPA=SPA. As the GARP message is periodically transmitted, it is denoted Periodic ARP, PGARP. The time period between two sent PGARP messages towards a certain second node 118 may be denoted message interval or message issuing interval. Further, the issuing device 116 is configured to generate and transmit Ethernet Address Resolution Protocol, ARP, request messages. ARP messages are described in more detail in reference [4], see reference list in the end of the Detailed Description section of this disclosure.

For example, two user equipments, computers A and B, are in an office, connected to each other on the office local area network by Ethernet cables and network switches, with no intervening gateways or routers. Computer A wants to send a packet to B. Through other means, it determines that B's IP address is 192.168.0.55. In order to send the message, it also needs to know B's MAC address. First, A uses a cached ARP table to look up 192.168.0.55 for any existing records of B's MAC address (00:eb:24:b2:05:ac). If the MAC address is found, it sends the IP packet on the link layer, L2, to address 00:eb:24:b2:05:ac via the local network cabling. If the cache did not produce a result for 192.168.0.55, A has to send a broadcast ARP message (destination ff:ff:ff:ff:ff:ff) requesting an answer for 192.168.0.55. B responds with its MAC address (00:eb:24:b2:05:ac). B may insert an entry for A into its own ARP table for future use. The response information is cached in A's ARP table and the message can now be sent.

Ethernet ARP messages may also be used as an announcement protocol. This is useful for updating other hosts' mapping of a hardware address when the sender's IP address or MAC address has changed. Such an announcement, also called a gratuitous ARP message, is usually broadcast as an ARP request containing the sender's protocol address (SPA) in the target field (TPA=SPA), with the target hardware address (THA) set to zero. An alternative is to broadcast an ARP reply with the sender's hardware and protocol addresses (SHA and SPA) duplicated in the target fields (TPA=SPA, THA=SHA).

An ARP announcement is not intended to solicit a reply; instead it updates any cached entries in the ARP tables of other hosts that receive the packet. The operation code may indicate a request or a reply because the ARP standard specifies that the operation code is only processed after the ARP table has been updated from the address fields.

Many operating systems perform gratuitous ARP during startup. That helps to resolve problems which would otherwise occur if, for example, a network card was recently changed (changing the IP-address-to-MAC-address mapping) and other hosts still have the old mapping in their ARP caches.

Gratuitous ARP is also used by some interface drivers to provide load balancing for incoming traffic. In a team of network cards, it is used to announce a different MAC address within the team that should receive incoming packets.

The proposed connectivity check mechanism applies periodically sent Ethernet ARP request messages being sent to ff:ff:ff:ff:ff:ff hardware (MAC) broadcast address with the source hardware (MAC) address of the sender device. Sender Protocol Address (SPA) and Target Protocol Address (TPA) are both set to the L3 protocol address of the machine issuing the ARP request message. In case IPv4 is applied as a L3 protocol, then SPA and TPA both equal to the IP address of the first node comprising the issuing device.

These ARP message types are often referred to as Gratuitous ARP messages.

According to arrangements and methods described hereafter, Periodical Gratuitous ARP messages (PGARP) are sent over the Ethernet broadcast domain periodically with a pre-defined time interval. Time interval shall be tuned to the system's requirements and characteristics. PGARP messages are sent by the first nodes 112. PGARP message interval shall be set to the same value in the whole broadcast domain.

Each network node in a Ethernet broadcast domain system maintain an ARP table which reflects live connections at any given time on L2 towards all applied L3 addresses used as next hops in the system.

With PGARP messages the first nodes announce that links towards the second nodes 118 are alive.

The second nodes 118, which may be considered as the receiving hosts, comprise a number of components and elements for handling an ARP message and other elements and components necessary for the functionality of a second node. Other elements and components are not illustrated only for the purpose of avoiding details unnecessary for the understanding of the operation of the methods and arrangement.

According to the illustrated examples of embodiments, each second node 118 is provided with a listening device 120. The listening device 120 comprises a receiving device 122 configured to receive an ARP message periodically sent from one of said first nodes 112 over a data transmission path 110 and storing means 124 configured to store the time instant when said ARP message was received as an entry of the latest received ARP message from the first node 118 in a record 134 comprising entries corresponding to one or more data paths 110 to said one or more first nodes 112. The listening device 120 also comprises at least one timer 132. The timer 132 is started or restarted and runs for a predetermined time period, herein denoted aging value. When said time period has run out, timer expires, and the connectivity check is performed. The timer automatically starts again after each ended period. It should be noted that in some embodiments there may different timers for different entries, e.g. one timer for one group of entries corresponding to a group of data transmission paths and additional timers for other data paths in the Ethernet broadcast domain. The listening device is further provided with checking means 126 configured to detect connectivity failure by periodically checking said record 134 for entries in relation to a predetermined threshold value, aging value, and to detect if one or more of said entries have exceeded said predetermined threshold value.

The checking means 126 is further configured to notify a service entity 128 if a connectivity failure has been detected. Said service entity may be incorporated in the listening device 120, but in some embodiments the listening device 120 is connected to the service entity being placed outside the listening device.

The service entity 128 is configured to send a notification message as an alert and/or alarm message to a subscriber connected to the second node and/or a responsible party, e.g. the responsible operator or maintenance system of the Ethernet LAN, to inform about the connectivity failure of a data transmission path. The responsible party may then take care of the failing path and/or redirect the data packet traffic to a data path which is still up and working. The message may be sent to a maintenance node comprising an application which is triggered by the received message to repair the failing data path. By means of a failover mechanism, the service entity 128 may direct data transmission over a data path 110 to another of said first nodes 112 for which connectivity failure has not been detected.

The listening device 120 and its components and elements described above are controlled by a controller 130. The listening device 120 may either comprise the controller 130 or be controlled by a separate controller 130.

Embodiments of the issuing device 116 and the listening device 120 may be implemented in digital electronically circuitry, or in computer hardware, firmware, software, or in combinations of them. Embodiments may be implemented in a computer program product tangibly embodied in a machine readable storage device for execution by a programmable processor; and method steps may be performed by the programmable processor, such as the controller 130, executing a program of instructions to perform functions of the invention by operating on input data and generating output.

Embodiments may advantageously be implemented in one or more computer programs that are executable on a programmable system including at least one programmable processor coupled to receive data and instructions from, and to transmit data and instructions to, a data storage system, at least one input device, and at least one output device. Each computer program may be implemented in a high-level procedural or object-oriented programming language or in assembly or machine language if desired; and in any case, the language may be a compiled or interpreted language.

Generally, the controller 130 will receive instructions and data from a read-only memory and/or a random access memory. Storage devices suitable for tangibly embodying computer program instructions and data include all forms of non-volatile memory, including by way of example semiconductor memory devices, such as EPROM, EEPROM, and flash memory devices; magnetic disks such internal hard disks and removable disks; magneto-optical disks; and CD-ROM disks. Any of the foregoing may be supplemented by, or incorporated in, specially designed ASICs (Application Specific Integrated Circuits).

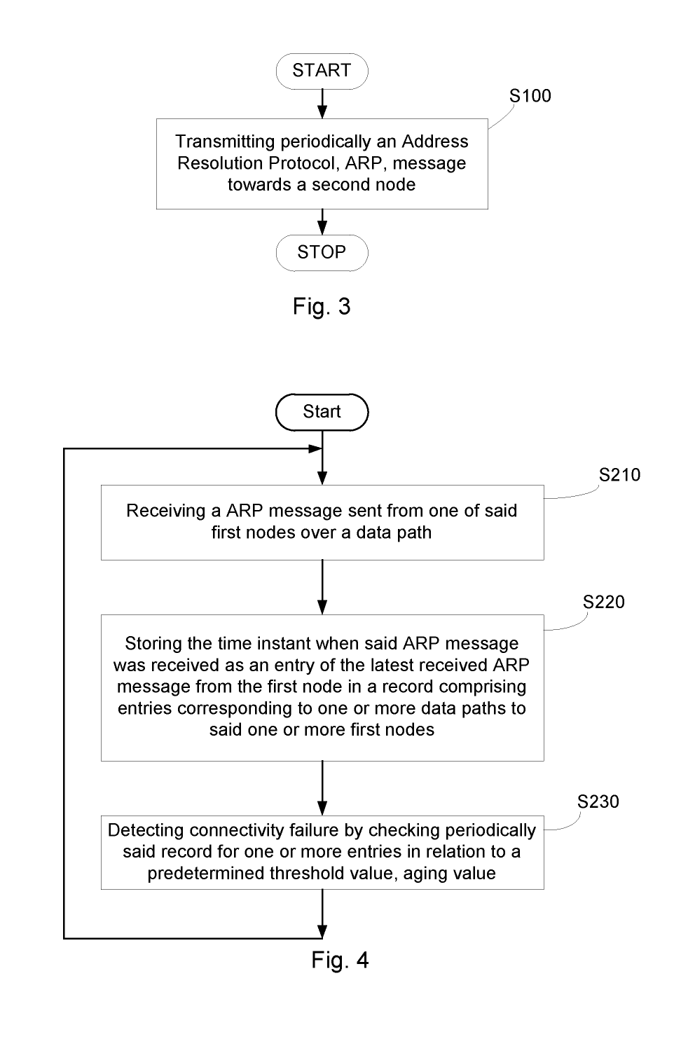

The issuing device 116 and listening device 120 are configured to support a method and embodiments thereof for checking connectivity and detecting connectivity failure of data transmission paths. How the different components and elements of the issuing device and listening device operate and cooperate for supporting said method and embodiments thereof is described in more detail with reference to FIGS. 3, 4 and 5 hereafter.

FIG. 3 is a flowchart illustrating of the method for enabling checking connectivity and detecting connectivity failure of data transmission paths between one or more first nodes and one or more second nodes in an Ethernet broadcast network. The first node is therefore configured to:

S100:—Transmitting periodically an Address Resolution Protocol, ARP, message towards a second node. The ARP message is generated and transmitted periodically by means of the issuing device 116. Further, the Address Resolution Protocol, ARP, message is preferably a Periodic Gratuitous ARP message comprising a Sender's Protocol Address, SPA, field and a Target Protocol Address, TPA, field. The issuing device is further configured to set the Sender's Protocol Address, i.e. the protocol address of the first node, into the TPA field, thus resulting in that TPA=SPA, i.e. both fields comprises the same address.

FIG. 4 is a flowchart illustrating an example of the method in a second node.

The Ethernet broadcast network comprises one or more first nodes, each of said first nodes comprises an issuing device, and one or more second nodes, each of said second nodes comprises a listening device. According to the method, the listening device 120 is configured to:

S210:—Receive an ARP message periodically sent from one of said first nodes over a data path. The issuing device 116 is configured to generate and transmit Periodical Gratuitous ARP messages, PGARP, over a data transmission path over the Ethernet broadcast domain periodically with a pre-defined time interval towards the second node 118, which may be a subscriber host. The predetermined time interval, denoted message interval, shall be tuned to the system's requirements and characteristics. PGARP messages are sent by the first nodes 112. PGARP message interval shall be set to the same value in the whole broadcast domain. The PGARP message is usually broadcast as an ARP request containing the sender's protocol address (SPA) in the target field (TPA=SPA), with the target hardware address (THA) set to zero.

The listening device 120 comprises a receiving device 122 configured to receive each ARP message periodically sent. The issuing device 116 is also configured to send ARP request messages, which the receiving 122 device also is able to receive and handle as stated in the standard document [4], see reference list.

The method further comprises:

S220:—Store the time instant when said ARP message was received as an entry of the latest received ARP message from the first node in a record comprising entries corresponding to one or more data transmission paths to said one or more first nodes. The listening device 118 is therefore provided with storing means 124, which is configured to store the time instant when said ARP message was received as an entry of the latest received ARP message from the first node 118 in a record 134. Said record 134 may comprise entries corresponding to one or more data paths 110 to said one or more first nodes 112. Said record may be a standard Address Resolution Protocol, ARP, table that has been modified to store even time instants of received ARP messages. The ARP table stores the peer MAC addresses to which the ARP messages are addressed.

The method further comprises:

S230:—Detect connectivity failure by periodically checking said record for one or more entries in relation to a predetermined threshold value, aging value. The listening device 118 is further provided with checking means 126 configured to detect connectivity failure by periodically checking said record for entries in relation to a predetermined threshold value, denoted aging value, and to detect if one or more of said entries have exceeded said predetermined threshold value. The aging value may preferably be set to a multiple of the message interval. The checking means 126 may further be configured to notify a service entity 128 if a connectivity failure has been detected. Said service entity may be incorporated in the listening device 120, but in some embodiments the listening device 120 is connected to the service entity being placed outside the listening device.

The service entity 128 may be configured to send a notification message as an alert and/or alarm message to a subscriber connected to the second node and/or a responsible party, e.g. the responsible operator of the Ethernet LAN, to inform about the connectivity failure of a data transmission path. The responsible party may then take care of the failing path and/or redirect the data packet traffic to a data path which is still up and working. The message may be sent to a maintenance node comprising an application which is triggered by the received message to repair the failing data path. The service entity 128 may also have been configured to direct data transmission over a data path 110 to another of said first nodes 112 for which connectivity failure has not been detected by means of a failover mechanism.

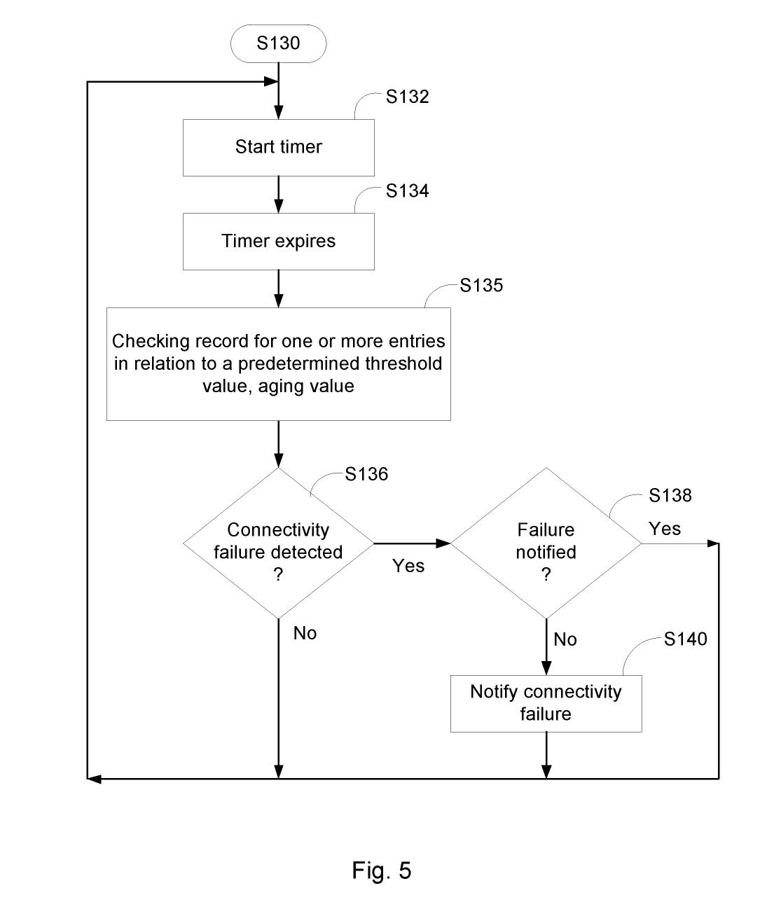

In the following, the checking and detecting process is described in more detail with reference to FIG. 5.

FIG. 5 is a flowchart of an embodiment of the checking and detecting process S230. The checking and detection mechanism is illustrated for a given monitored first node, e.g. edge node or issuing host node, 112. For each first node 112 in the network the same mechanism shall be applied, but the aging value can differ between different second nodes 118, e.g. subscriber hosts.

Said process starts with the step of starting the timer in the checking means 126 that checks the record of entries in the record 134, e.g. the ARP table:

S232:—Start timer. The timer 132 of the listening device 120 is started or restarted and runs for a predetermined time period, herein denoted aging value. When said time period has run out, timer expires, S234, the connectivity check is performed. The timer automatically restarts after each expiration of a time period;

S234:—Timer expires. The timer 132 runs for a predetermined time, which is the interval set between two successive checks performed by the checking means 126. During this interval, a number of PGARP messages are periodically received from each one of the first nodes connected to the second node. The number of PGARP messages received during the threshold value interval depends on the (PGARP) message (issuing) interval. The threshold value can be unique per each second node 118 in the domain, but it is preferably a multiple of the PGARP message interval. The time instant for each received message is stored and thereby updating the entry of a data path corresponding to the first node from which the PGARP message was received. If connectivity of one data path is lost, the entry of said data path and first node will after a while exceed the aging value as the time instant for said entry will not be updated;

S235: Checking record for one or more entries in relation to a predetermined threshold value, aging value. The checking means 126 in the second nodes periodically checks their ARP tables 134, to see if the timer 132 for entries in the record, or ARP (cache) tables 134, indicates a time longer than the pre-defined threshold value, Aging Value, has passed since last a message was received from that specific first node;

S236: Connectivity failure detected? If the checking means does not detect any entries having time values that exceed the threshold value, i.e. aging value, the condition in S236 is not fulfilled, No, the checking and detecting process and mechanism restarts the timer, S232. If, however, the checking means 126 does detect one or more entries having time values that exceed the threshold value, i.e. aging value, the condition in S236 is fulfilled, Yes, the checking means 126 is configured to notify a service entity 128 if a connectivity failure has been detected;

S238: Failure notified? As the checking and detecting process runs on without stop, and if the detected connectivity failure has not been taken care of, a notification will be sent from the checking means 126 for each loop of the process. The service entity may therefore have been configured to only accept the first connectivity failure notification for a certain data path and first node. Thus, service entity is configured to check if the connectivity failure has already been notified, or not. If the condition is fulfilled, yes, the timer is restarted, S232, without the sending of any new notification message. The service entity may store a sent message, and the storage is checked if it contains a message corresponding to the current notification. If said condition is not fulfilled, a notification message is sent in S240;

S240: Notify connectivity failure. The service entity 128 is configured to generate and send a notification message as an alert and/or alarm message to a subscriber connected to the second node and/or a responsible party, e.g. the responsible operator or management system of the Ethernet LAN, to inform about the connectivity failure of a data transmission path. The responsible party may then take care of the failing path and/or redirect the data packet traffic to a data path which is still up and working. The message may be sent to a maintenance node comprising an application which is triggered by the received message to repair the failing data path. The service entity 128 could also have been configured to direct data transmission over a data path 110 to another of said first nodes 112 for which connectivity failure has not been detected by means of a failover mechanism. The timer or timers are restarted, S232, after the service device 128 has been trigged by the checking device.

The above described examples and embodiments of the arrangement and method for checking connectivity and detecting connectivity failure of data transmission paths have a number of advantages:
Fast detection mechanism for failures in the physical layer (L1), data-link layer (L2) and data network layer (L3);
Works on L2;
Scalable according to system's requirements;
Suitable when Ethernet Operation, Administration and Maintenance functionality is not possible to be used (e.g. with a Base Station Control, eNB, etc) and L2 mechanism is preferred;
Suitable if IPv6 Neighbor Discovery is not available;
Suitable if BFD is not desired due to huge blade systems where BFD requires tremendous amount of supervision sessions;
Easy enhancement of existing implementations already in place;
Each second node, i.e. subscriber host, can decide when to trigger the failover mechanism. The first nodes, i.e. edge nodes, can use the same configuration regardless the configuration of the second nodes;
Compared to ICMP Ping based supervision method, the new solution uses less IP addresses and subnets, e.g. in a Base Station Control, eNB, etc.;
The solution provides less complexity to implement than the other solutions.

A number of embodiments have been described. It will be understood that various modifications may be made without departing from the scope of this disclosure. Therefore, other implementations are within the scope of the following claims.

### REFERENCE LIST

[1] Neighbor Discovery for IP version 6 (IPv6), IETF RFC 4861
[2] Bidirectional Forwarding Detection (BFD), IETF RFC 5880
[3] IEEE 802.1ag—Connectivity Fault Management
[4] An Ethernet Address Resolution Protocol, IETF RFC 826

1. A method for checking connectivity and detecting connectivity failure of data transmission paths between one or more first nodes and one or more second nodes in an Ethernet broadcast network, wherein the method in a second node comprises:
receiving an Address Resolution Protocol (ARP) message periodically sent from one of said first nodes over a data path;
storing the time instant when said ARP message was received as an entry of the latest received ARP message from the first node in a record comprising entries corresponding to one or more data transmission paths to said one or more first nodes; and
detecting connectivity failure by periodically checking said record for one or more entries in relation to a predetermined threshold aging value.

2. The method according to claim 1, wherein the receiving of an ARP message implies receiving a Periodical Gratuitous ARP message, which is an ARP message that is periodically sent by the first nodes where the periodicity is a predetermined message interval.

3. The method according to claim 1, wherein the record in which the time instant is stored is an ARP table, comprising time instants of other received ARP messages and the peer MAC addresses to which they are addressed.

4. The method according to claim 1, wherein the detection of connectivity failure further comprises:
notifying a service entity if a connectivity failure has been detected.

5. The method according to claim 4, wherein the service entity is configured to send a notification message as an alert and/or alarm message.

6. The method according to claim 4, wherein the service entity is configured to direct data transmission from a failing data path to another of said first nodes for which connectivity failure has not been detected.

7. The method according to claim 2, wherein the threshold aging value, aging value, is set to a multiple of the message interval.

8. A method for enabling checking of connectivity and detecting connectivity failure of data transmission paths between one or more first nodes and one or more second nodes in an Ethernet broadcast network, wherein the method in a first node comprises:
transmitting periodically an Address Resolution Protocol (ARP) message towards a second node.

9. The method according to claim 8, wherein the ARP message is a Periodic Gratuitous ARP message comprising a Sender's Protocol Address field and a Target Protocol Address field, and wherein the Sender's Protocol Address is set into the TPA field.

10. An arrangement for checking connectivity and detecting connectivity failure of data transmission paths between one or more first nodes in an Ethernet broadcast network, each of said first nodes comprises an issuing device and one or more second nodes, each of said second nodes comprises: a listening device, wherein said listening device comprises a receiving device configured to receive an Address Resolution Protocol (ARP) message periodically sent from one of said first nodes over a data transmission path; storing means configured to store the time instant when said ARP message was received as an entry of the latest received ARP message from the first node in a record comprising entries corresponding to one or more data paths to said one or more first nodes; and checking means configured to detect connectivity failure by periodically checking said record for entries in relation to a predetermined threshold aging value and to detect if one or more of said entries have exceeded said predetermined threshold aging value.

11. The arrangement according to claim 10, wherein the receiving device is configured to receive a PGARP message, which is an ARP message that is periodically sent by the first nodes where the periodicity is a predetermined message interval.

12. The arrangement according to claim 10, wherein the record in which the time instant is stored is an ARP table comprising time instants of other received ARP messages and the peer MAC addresses to which they are addressed.

13. The arrangement according to claim 10, wherein the checking means is further configured to notify a service entity if a connectivity failure has been detected.

14. The arrangement according to claim 13, wherein the service entity is configured to send a notification message as an alert and/or alarm message.

15. The arrangement according to claim 13, wherein the service entity is configured to direct data transmission from a failing data path to another of said first nodes for which connectivity failure has not been detected.

16. The arrangement according to claim 10, wherein the threshold aging value is set to a multiple of the message interval.

17. An arrangement for checking connectivity and detecting connectivity failure of data transmission paths between one or more first nodes and one or more second nodes in an Ethernet broadcast network, wherein the arrangement in a first node comprises an issuing device configured to transmit periodically an Address Resolution Protocol (ARP) message towards a second node.

18. The arrangement according to claim 17, wherein the ARP message is a Periodic Gratuitous ARP message comprising a Sender's Protocol Address field and a Target Protocol Address field, wherein the issuing device is configured to set the Sender's Protocol Address into the TPA field.
